(19) United States
(12) Patent Application Publication
(10) Pub. No.: US 2011/0143664 A1
(43) Pub. Date: Jun. 16, 2011

(54) SYSTEM AND METHOD FOR BLUETOOTH PUSH TO TALK

(76) Inventors: James R. Fuccello, Patchogue, NY (US); Taheer Khazi, Central Islip, NY (US)

(21) Appl. No.: 12/636,986

(22) Filed: Dec. 14, 2009

(51) Int. Cl. H04B 7/005; H04B 7/00

(52) U.S. Cl. 455/41.2; 455/518

(57) ABSTRACT

A wireless communication device is described. The wireless communication device includes a wireless transceiver capable of communicating with a Bluetooth-enabled wireless device having a call button for initiating a command. A control switch is coupled to the wireless transceiver for initiating a push to talk session in the wireless transceiver. A processor is coupled to the control switch and the wireless transceiver. The processor initiates the push to talk session upon receiving the command from the Bluetooth-enabled wireless device.

### FIELD OF THE INVENTION

This description relates to a system and method for establishing a push to talk session in a wireless communication system.

### BACKGROUND

The “push to talk” functionality available on some mobile phone systems operate similarly to that of a two-way radio or walkie-talkie. The push to talk function allows one party to quickly and directly poll another party's mobile telephone through a dedicated channel. push to talk functionality was originally offered through Motorola's Integrated Digital Enhanced Network (iDEN™) and Nextel Communication's Direct Connect™ service, and has now been extended to other networks, including Code Division Multiple Access (CDMA) networks and Global System for Mobile communications (GSM) networks.

### SUMMARY

In one aspect, the invention is embodied in a wireless communication device. The wireless communication device includes a wireless transceiver that is capable of communicating with a Bluetooth-enabled wireless device having a call button for initiating a command. A control switch is coupled to the wireless transceiver for initiating a push to talk session in the wireless transceiver. A processor is coupled to the control switch and the wireless transceiver. The processor initiates the push to talk session upon receiving the command from the Bluetooth-enabled wireless device.

In one embodiment, the processor initiates the push to talk session by attempting to gain the floor. The command can be transmitted to the wireless transceiver upon momentary activation of the call button. The Bluetooth-enabled wireless device can include a transceiver, a loudspeaker and a microphone.

In one embodiment, the call button of the Bluetooth-enabled wireless device is capable of initiating different commands in response to activating the call button for different durations. In one example, activating the call button for a predetermined duration initiates text-to-speech functionality in the wireless communication device.

In another aspect, the invention is embodied in a method for establishing a push to talk session in a wireless communication system. The method includes a pairing a Bluetooth-enabled wireless device having a call button to a wireless communication device having a wireless transceiver. The call button on the Bluetooth-enabled wireless device is activated to send a command to the wireless communication device. A push to talk session is initiated in the wireless communication device in response to the command from the Bluetooth-enabled wireless device.

In one embodiment, the pairing is a fast-pairing. In one embodiment, the push to talk session is initiated by gaining the floor or releasing the floor. In one example, the activating step includes pushing the call button on the Bluetooth-enabled wireless device.

In one embodiment, the push to talk session in the wireless communication device is initiated by intercepting the command from the Bluetooth-enabled wireless device in the wireless communication device. In one embodiment, activating the call button for different durations results in initiating different commands in the wireless communication device.

In another aspect, the invention is embodied in a wireless communication system. The system includes a Bluetooth-enabled wireless device having a call button for initiating a command. The system also includes a wireless communication device having a wireless transceiver that is capable of communicating with the Bluetooth-enabled wireless device and a processor that initiates a push to talk session in the wireless communication device upon receiving the command from the Bluetooth-enabled wireless device.

In one embodiment, the processor initiates the push to talk session by attempting to gain the floor. In one embodiment, the processor terminates the push to talk session by releasing the floor. The system can also include a control switch that is coupled to the wireless transceiver for activating push to talk functionality in the wireless communication device. The call button initiates various commands in the wireless communication device as a function of at least one of the length and frequency of an activation of the call button.

The wireless communication device can be one of a cellular telephone, mobile computer, desktop computer, personal digital assistant (PDA) and a walkie-talkie. The Bluetooth-enabled wireless device can include a transceiver, a loudspeaker and a microphone.

### BRIEF DESCRIPTION OF THE FIGURES

This invention is described with particularity in the detailed description. The above and further advantages of this invention may be better understood by referring to the following description in conjunction with the accompanying drawings, in which like numerals indicate like structural elements and features in various figures. Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. Also, reference designators shown herein in parenthesis indicate components shown in a figure other than the one in discussion. For example, talking about a device (10) while discussing Figure A would refer to an element, 10, shown in figure other than Figure A.

FIG. 1 illustrates a block diagram of a Bluetooth-enabled wireless device according to one embodiment of the invention.

FIG. 2 illustrates a block diagram of a wireless communication device according to one embodiment of the invention

FIG. 2 is a block diagram of a Bluetooth-enabled wireless device according to one exemplary embodiment of the invention.

FIG. 3 illustrates a modified Bluetooth stack according to one embodiment of the invention.

FIG. 4 illustrates a push to talk system according to one embodiment of the invention.

FIG. 5 is a flow chart of a method of loading push to talk software in a device according to one embodiment of the invention.

FIG. 6A is a flow chart of a method for Bluetooth push to talk according to one embodiment of the invention.

FIG. 6B illustrates an enable/disable sub-process according to one embodiment of the invention.

FIG. 6C illustrates the process special events sub-process according to one embodiment of the invention.

FIG. 6D illustrates the gain/release sub-process according to one embodiment of the invention.

### DETAILED DESCRIPTION

When using a push to talk feature on a mobile telephone, a user first selects a recipient from a directory, then presses a push to talk button on the mobile telephone. The mobile device then instantly transmits a request through the network to the recipient's device. Provided the floor is available and the recipient is within the operable service area, their mobile telephone will hear the sender's voice without the dial, ring, and answer delay associated with the normal mobile telephone calling process.

Conventional push to talk systems require that when using the push to talk function, a user must continuously hold down the push to talk button while speaking. The user must then release the push to talk button to release the floor and receive messages from others.

Before describing in detail embodiments that are in accordance with the present invention, it should be observed that the embodiments reside primarily in combinations of method steps and apparatus components related to push to talk communications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of establishing push to talk communication sessions as described herein. The non-processor circuits may include, but are not limited to, a radio receiver, a radio transmitter, signal drivers, clock circuits, power source circuits, and user input devices. As such, these functions may be interpreted as steps of a method to perform establishment of push to talk communication sessions. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” In this document, relational terms such as first and second, top and bottom, and the like may be used solely to distinguish one entity or action from another entity or action without necessarily requiring or implying any actual such relationship or order between such entities or actions.

The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The terms “coupled” or “connected” as used herein is defined as connected, although not necessarily directly and not necessarily mechanically. A device or structure that is “configured” in a certain way is configured in at least that way, but may also be configured in ways that are not listed.

A system and method for establishing a push to talk communication session is described. The system and method allow a user to initiate, terminate, and perform other operations in conjunction with a push to talk session without handling the mobile unit (e.g., cellular telephone, personal digital assistant, mobile computer, or laptop) that includes the push to talk functionality. The invention enables the use of wireless headsets, for example, to conduct push to talk communications without touching the mobile unit.

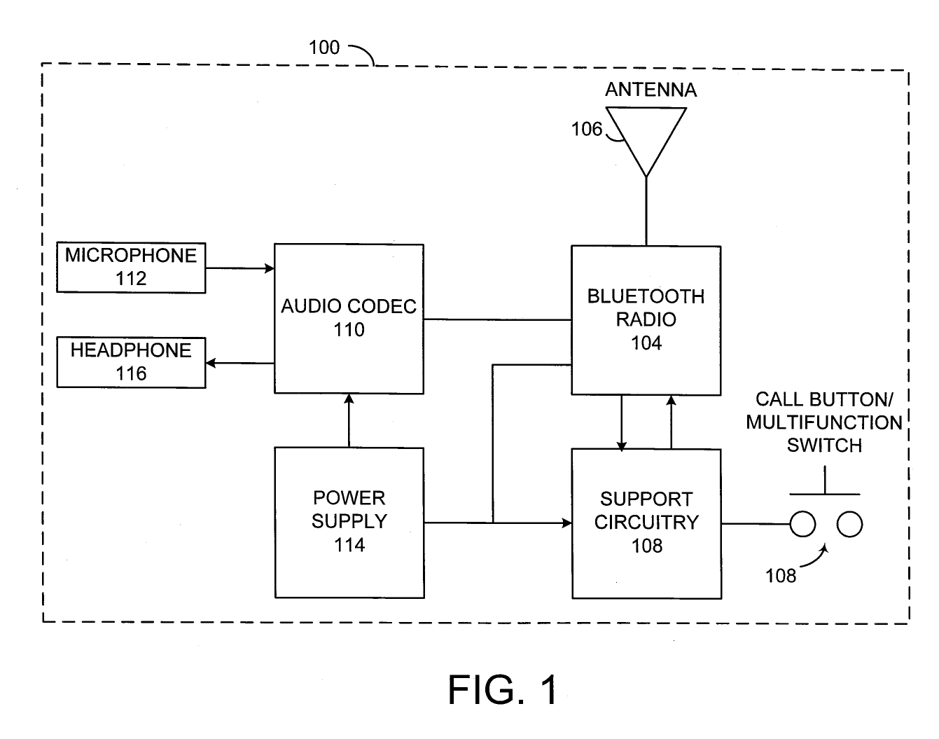

FIG. 1 illustrates a block diagram of a Bluetooth-enabled wireless device 100 according to one embodiment of the invention. In one embodiment, the device 100 is a Bluetooth enabled headset, for example. The Bluetooth-enabled wireless device 100 includes a call button 102 capable of actuating the various functions of the device 100. The call button 102 can be a multi-function button that controls multiple operations. For example, the Bluetooth-enabled wireless device 100 is generally configured to be worn on a user's ear. Due to size constraints, the device may only include one or a few buttons for multiple functions. As such, the call button 102 may work to both answer and hang-up incoming calls, for example, depending upon the current state of the Bluetooth-enabled wireless device 100.

The Bluetooth-enabled wireless device 100 includes a Bluetooth transceiver 104 capable of communicating by transmitting electronic signals to a remote electronic device (not shown). For example, the Bluetooth transceiver 104 may be a local area, low power transmitter capable of sending electronic signals including voice and software control commands to, for example, a wireless communication device (not shown). Thus, the Bluetooth-enabled wireless device 100 includes support circuitry 108 coupled with the call button 102 for detecting an actuation of the call button 102. The support circuitry 108 can include a microprocessor, memory, signal processing and other logic circuitry. An audio codec 110 can be used to convert audible voice received by a microphone 112 into logic signals for transmission to a remote device. The audio codec 110 is coupled to the Bluetooth transceiver 104. The Bluetooth transceiver 104 is coupled to an antenna 106.

The Bluetooth-enabled wireless device 100 includes a power supply 114. The power supply 114 can be a battery, such as a rechargeable battery or a disposable battery. The power supply 114 provides power to the support circuitry 108, the codec 110 and the Bluetooth transceiver 104.

The Bluetooth-enabled wireless device 100 includes the microphone 112 and a loudspeaker 116 coupled to the codec 110. The microphone 112 and the loudspeaker 116 are configured for receiving and delivering analog audio from/to a user. The user can position the Bluetooth-enabled wireless device 100 to the ear by way of a pliable ear loop (not shown). The microphone 112 can be mounted on a boom (not shown) so as to better receive voice data from the user. The Bluetooth-enabled wireless device 100 can include other control buttons (not shown) besides the call button 102 can be included to control other functions, including power on/off and volume.

The Bluetooth-enabled wireless device 100 can communicate with a wireless communication device. In one illustrative embodiment, the wireless communication device is a mobile telephone. It will be clear to those of ordinary skill in the art having the benefit of this disclosure that the invention is not so limited. For example, the wireless communication device can be a personal computer having a wireless capability that is configured to establish Voice Over Internet Protocol (VoIP) communications.

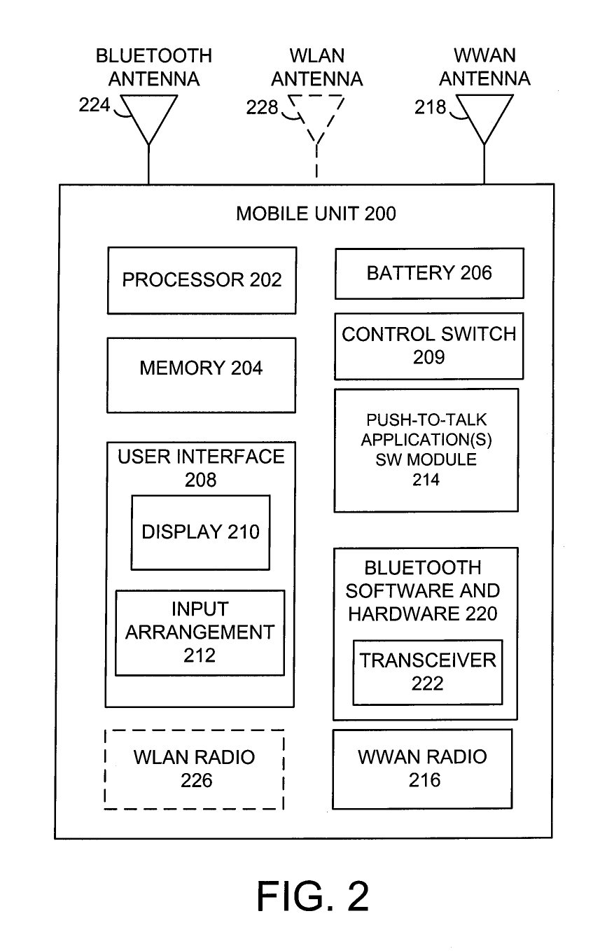

FIG. 2 illustrates a block diagram of a wireless communication device 200 according to one embodiment of the invention. The wireless communication device 200 can be a mobile computer, a cellular telephone, a personal digital assistant having wireless connectivity, and/or any device that includes push to talk functionality. The wireless communication device 200 includes a processor 202. The processor 202 can be a general purpose microprocessor or a customizable integrated circuit such as an application-specific integrated circuit (ASIC). In one embodiment, the processor includes a digital signal processor (DSP).

The wireless communication device 200 can also include memory 204. The memory 204 can include random access memory (RAM), read-only memory (ROM), flash memory, or any other suitable memory. The memory 204 can reside on an erasable programmable read only memory (EPROM). A battery 206 is connected to the wireless device 200 to provide power. The battery 206 can be a disposable battery or a rechargeable battery. For example, the battery 206 can be a lithium ion battery or a nickel-cadmium (NiCd) battery. Any suitable battery can be used. The wireless device 200 can also include a connector (not shown) that accepts a power adapter for use with standard alternating current (AC) power.

In one embodiment, the wireless communication device 200 includes a user interface 208. The user interface 208 is configured to allow a user to interact with the device 200. The user interface 208 can include a display 210, such as a liquid crystal display (LCD). The display 210 is configured to provide visual feedback to the user during operation of the wireless communication device 200. The display 210 can also include touch screen functionality. The user interface 208 can also include an input arrangement 212. The input arrangement 212 is configured to allow the user to input various commands into the wireless communication device 200. The input arrangement 212 can include a keypad, control buttons, a thumbwheel, a trackball, a touch pad, the touch screen, a microphone or any other suitable input device.

The wireless communication device 200 also includes operating system software that can reside in the memory 204. The operating system software can include a graphical user interface (GUI) that is displayed on the display 210. A push to talk software application 214 can also reside in the memory 204. The push to talk software application 214 can interface with the operating system software. The push to talk software application 214 enables the wireless device 200 to perform push to talk functionality. In one embodiment, the user interface 208 includes a control switch 209 that enables a push to talk session on the wireless device 200. The control switch 209 can be a push button, for example. The push to talk functionality will be described in more detail herein.

The wireless communication device 200 can optionally include a wireless wide area network (WWAN) radio 216. The WWAN radio 216 is coupled to an antenna 218. The antenna 218 can be a wireless wide area network (WWAN) antenna. The antenna 218 allows the wireless communication device 200 to communicate through a wireless network, such as a cellular network. The wireless communication device 200 can optionally include a wireless local area network (WLAN) radio 226 and antenna 228 to allow the wireless device 200 to communicate over a wireless local area network.

The wireless communication device 200 also includes a Bluetooth radio module 220. The Bluetooth radio module 220 includes both hardware and software. For example, the Bluetooth module 220 can include a wireless transceiver 222 as well as software. The software can include Bluetooth radio drivers and Bluetooth application software. The wireless transceiver 222 is coupled to a Bluetooth antenna 224. The wireless transceiver 222 and Bluetooth antenna 224 are configured to transmit and receive audio and data signals over relatively short distances. For example, the wireless communication device 200 can communicate with the Bluetooth-enabled wireless device 100 through a Bluetooth communication protocol when the wireless communication device 200 is in range of the Bluetooth-enabled wireless device 100. The communication is achieved when the devices are “paired” with each other.

In operation, the wireless communication device 200 is configured to communicate wirelessly with other devices over a public or private communication network. In one mode of operation, the wireless communication device 100 includes push to talk functionality. Push to talk functionality generally allows one party to speak to many parties in a “walkie-talkie”-like mode. In other embodiments, a push to talk session can occur between only two parties.

In order to initiate a push to talk session, a user wishing to transmit audio signal activates the control switch 209. The activation of the control switch 209 indicates that the user wishes to request the floor. The user will gain the floor if the floor is available. Many push to talk systems use a first-in, first-out system to determine the order with which the floor will be gained. The floor is release when the user releases the control switch 209. In other embodiments, the control switch 209 is a momentary switch and the user must activate the control switch once to gain the floor and once to release the floor. According to one embodiment of the invention, the wireless communication device 200 is paired with the Bluetooth-enabled wireless device 100 through Bluetooth communication protocols. For example, pairing can be achieved through standard Bluetooth pairing. Alternatively, the pairing can be achieved using fast pairing, through attempting to use common PIN codes.

The call button 102 on the Bluetooth-enabled wireless device 100 is typically used to send commands to the wireless communication device 200. As previously described, the call button 102 can be pressed one or more times depending on the command requested. In one embodiment of the invention, the commands sent from the call button 102 are monitored through software on the wireless device 200. When the appropriate command is sent, the software diverts the command to the push to talk module 214 on the wireless communication device 200. The push to talk module 214 then initiates a push to talk session by requesting the floor.

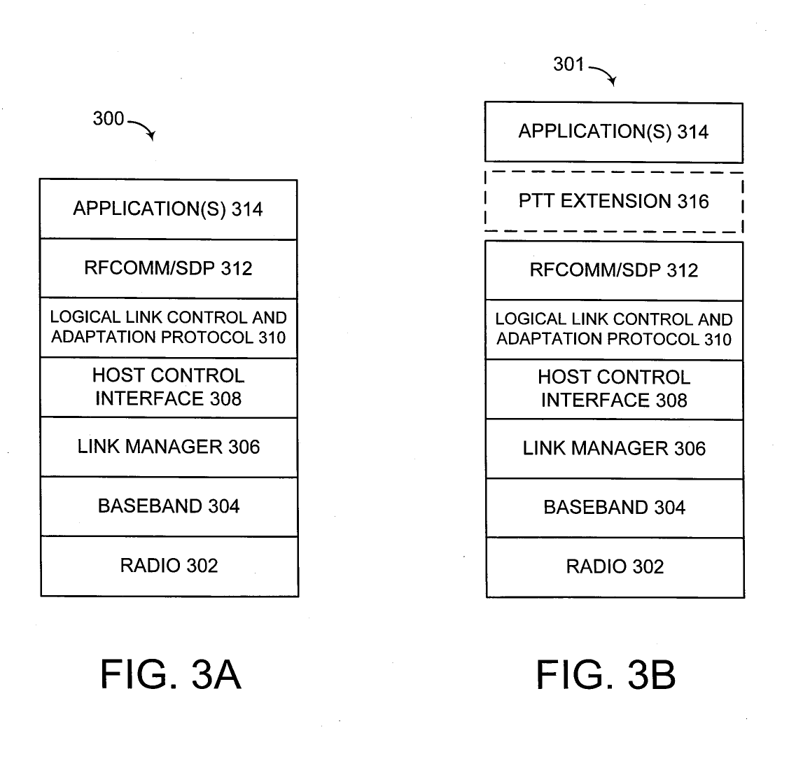

FIG. 3A and FIG. 3B illustrate Bluetooth protocol stacks 300 and 301, respectively, on the wireless communication device 200 according to an embodiment of the invention. The Bluetooth protocol stack is split in two parts: a “controller stack” containing the timing critical radio interface, and a “host stack” dealing with high level data. The controller stack is generally implemented in a low cost silicon device containing the Bluetooth radio and a microprocessor. The host stack is generally implemented as part of an operating system, or as an installable package on top of an operating system.

Turning to FIG. 3A, the Bluetooth protocol stack 300 includes seven layers. The first lowest layer is the radio 302. The radio 302 and the baseband layer 304 constitute the physical layer. The link manager 306 is used to control the radio link between two devices. The next layer is the host/control interface (HCI) 308. The HCI provides standardized communication between the host stack (e.g., a PC or mobile phone OS) and the controller (the Bluetooth IC). This standard allows the host stack or controller IC to be swapped with minimal adaptation. There are several HCI transport layer standards, each using a different hardware interface to transfer the same command, event and data packets. The most commonly used are USB (in PCs) and UART (in mobile phones and PDAs). The Logical link control and adaptation protocol (L2CAP) 310 passes packets to either the Host Controller Interface (HCI) 308 or on a hostless system, directly to the Link Manager 306. L2CAP 310 is used to communicate over the host ACL link. Its connection is established after the ACL link has been set up. L2CAP's functions include:
Multiplexing data between different higher layer protocols.
Segmentation and reassembly of packets.
Providing one-way transmission management of multicast data to a group of other Bluetooth devices.
Quality of service (QoS) management for higher layer protocols.

The Service discovery protocol (SDP) is bound to L2CAP 310. It is used to allow devices to discover what services each other support, and what parameters to use to connect to them. For example, when connecting a mobile phone to a Bluetooth headset, SDP will be used to determine which Bluetooth profiles are supported by the headset and the protocol multiplexor settings needed to connect to each of them.

The Radio frequency communication (RFComm) layer 312 is a simple set of transport protocols, made on top of the L2CAP protocol layer 310, providing emulated RS-232 serial ports (up to sixty simultaneous connections to a Bluetooth device at a time). RFComm 312 is sometimes called serial port emulation. The Bluetooth serial port profile is based on this protocol. RFComm 312 provides a simple reliable data stream to the user, similar to TCP. Many Bluetooth applications 314 use RFComm 312 because of its widespread support and publicly available API on most operating systems. Additionally, applications 314 that used a serial port to communicate can be quickly ported to use RFComm 312.

Turning to FIG. 3B, the Bluetooth protocol stack 301 includes eight layers. The Bluetooth protocol stack 301 includes all of the same layers as the Bluetooth protocol stack 300 of FIG. 3A and an additional layer referenced as the push to talk Extension 316. The push to talk Extension 316 is used to capture the command from the control button 102 on the Bluetooth-enabled wireless device 100 and divert a modified command to the push to talk module 214 on the wireless communication device 200. The push to talk module 214 will initiate a push to talk session on the wireless communication device 200 in response to the modified command. In one embodiment, a push to talk session can also be initiated by activating the control switch 209 on the wireless communication device 200. The position of the push to talk Extension layer 316 in the protocol stack 301 is shown for illustration purposes only and can be moved to a different position.

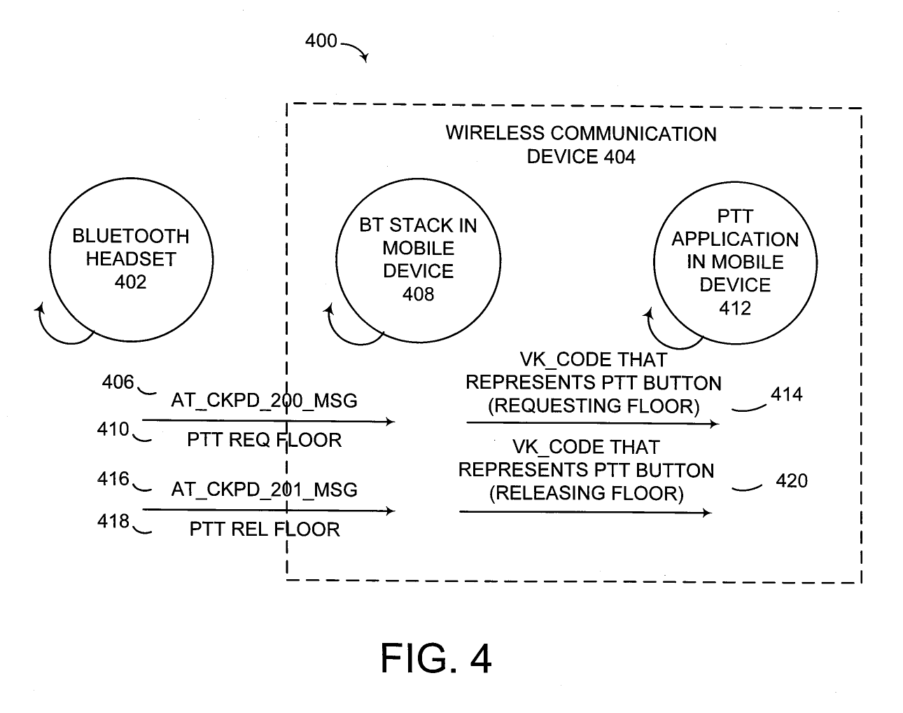

FIG. 4 illustrates a push to talk system 400 according to one embodiment of the invention. The push to talk system 400 includes a Bluetooth headset 402 and a wireless communication device 404 having push to talk functionality.

Upon pressing the call button (not shown) on the Bluetooth headset 402, the “AT_CKPD_{—}200 MSG” command 406 is transmitted to the wireless communication device 404. The PTT Extension in the Bluetooth Protocol stack 408 interprets the command as a push to talk floor request command 410. The command is modified and is transmitted to a push to talk Application 412 in the wireless communication device 404 as VK Code 414 that represents the requesting floor command normally received by activating the push to talk control switch (not shown) on the wireless communication device 404.

Upon pressing the call button (not shown) a second time on the Bluetooth headset 402, the “AT_CKPD_{—}201_MSG” command 416 is transmitted to the wireless communication device 404. The PTT Extension in the Bluetooth Protocol stack 408 interprets the command as a push to talk release floor command 418. The command is modified and is transmitted to a push to talk Application 412 in the wireless communication device 404 as VK Code 420 that represents the releasing floor command normally received by re-activating the push to talk control switch (not shown) on the wireless communication device 404. It should be noted that other AT_CKPD and VK messages could alternatively be used.

In one embodiment, the user activates the call button on the Bluetooth headset 402 to initiate a push to talk session and attempt to gain the floor. Once the push to talk session is established, the user continues to hold the call button while speaking. The user simply releases the call button to release control of the floor.

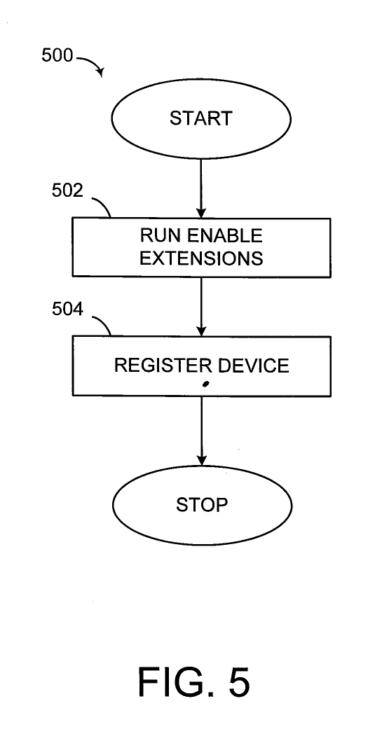

FIG. 5 is a flow chart 500 of a method of loading push to talk software in a device, such as the device 200 of FIG. 2, according to one embodiment of the invention. In a first step 502, the push to talk application is loaded into the operating system of the device 200 of FIG. 2. In a second step 504, the push to talk application registers the push to talk extension 316 of FIG. 3B into the operating system and the Bluetooth stack 301 of FIG. 3B.

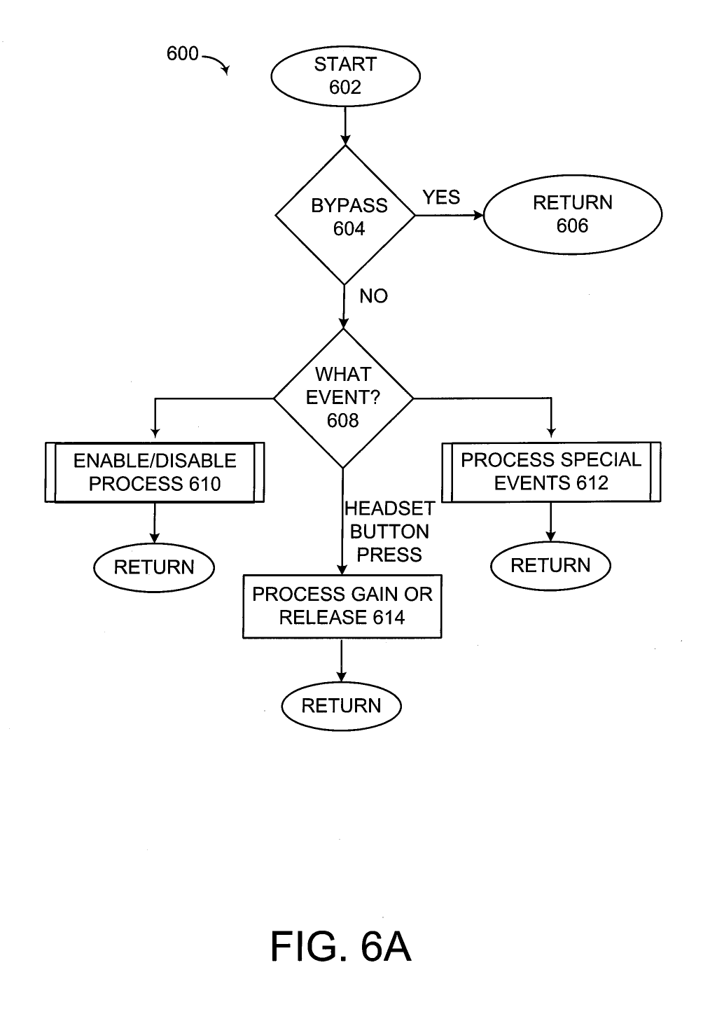

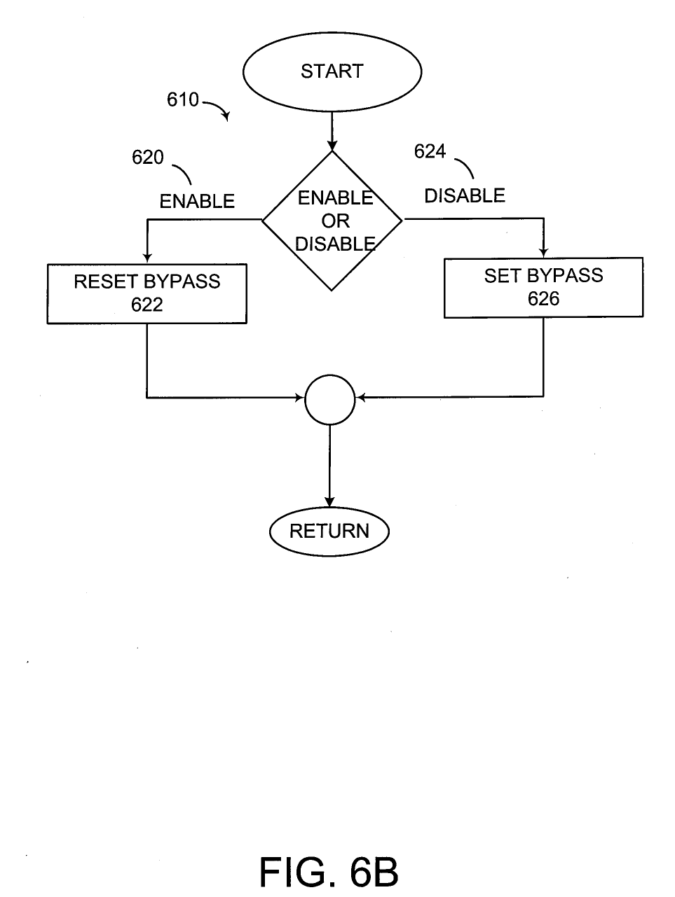

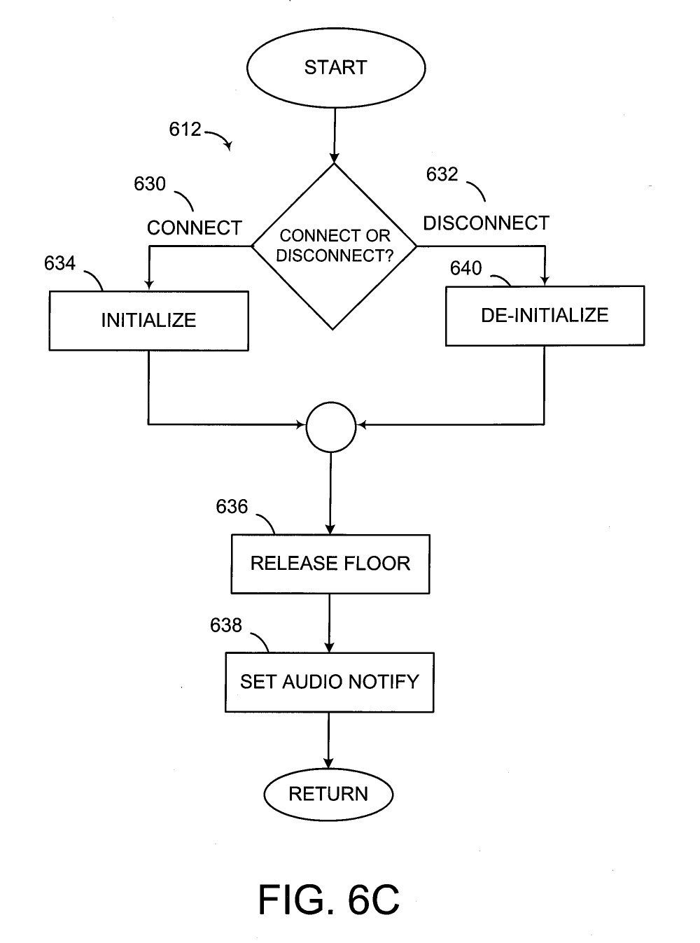

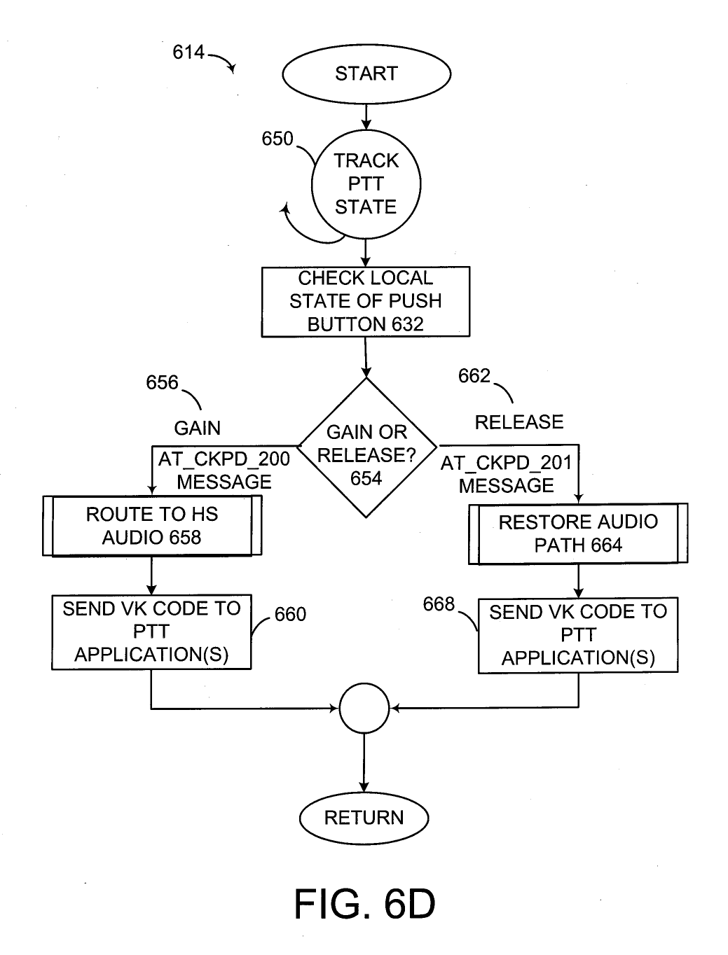

FIG. 6A is a flow chart 600 of a method for Bluetooth push to talk according to one embodiment of the invention. The method begins at step 602. If a decision is made to bypass the Bluetooth push to talk process at step 604, the process ends at step 606.

If a decision is made to proceed at step 604, the program determines how to proceed in step 608. The determination is related to a number of factors. One of three decisions can be made. The first decision is whether to enable or disable the Bluetooth push to talk process 610 which will be discussed in more detail with respect to FIG. 6B. The second decision is related to special events processing 612 which will be discussed in more detail with respect to FIG. 6C. The third decision is related to the process for gaining and releasing the floor 614 which will be discussed in more detail with respect to FIG. 6D. In one embodiment, a factor that determines the decision involves the call button on the Bluetooth headset. If the call button is activated, thereby indicating that a user wishes to gain or release the floor, then the program proceeds to step 614.

FIG. 6B illustrates an enable/disable sub-process 610 according to one embodiment of the invention. The Bluetooth push to talk process can be enabled using several methods. For example, the Bluetooth push to talk process can be enabled through a user interface on the wireless communication device. Alternatively, the Bluetooth push to talk process can be enabled using a command sent from the Bluetooth headset. When the Bluetooth push to talk process is enabled 620, a bypass routine is reset 622 in the Bluetooth protocol stack. This invokes the PTT extension 316 of FIG. 3B. The PTT extension 316 communicates with the push to talk module to enable the Bluetooth push to talk functionality according to the invention.

When the process is disabled 624, the bypass routine is set 626. The Bluetooth push to talk process can be disabled using several methods. For example, the Bluetooth push to talk process can be disabled through a user interface on the wireless communication device. Alternatively, the Bluetooth push to talk process can be disabled using a command sent from the Bluetooth headset. When the Bluetooth push to talk process is disabled 624, a bypass routine is set 626 in the Bluetooth protocol stack. This bypasses the PTT extension 316 of FIG. 3B and disables the Bluetooth push to talk functionality according to the invention.

FIG. 6C illustrates the process special events sub-process 612 according to one embodiment of the invention. The sub-process 612 determines the procedure for connecting 630 and disconnecting 632 the Bluetooth headset to the wireless communication device. When a connection or disconnection event occurs, the PTT extension 316 in FIG. 3B follows the process flow in FIG. 6C. Upon connection 630 the process flow proceeds to step 634, initialize. During initialize 634 all internal BT stack modifications are initialized and the audio processing, including routing are set up. This includes creating a SCO connection to the BT headset and then muting it. Following this activity the process ensures the PTT floor is in a known state 636 (released floor). Finally, an in-band audio notify prompt 638 is sent to the BT headset to verify the base connection.

The process flow for disconnect 632 is basically the reverse of the process described above. During disconnect 632 all internal BT stack modifications are de-initialized 640. The floor is then released 636 and an in-band disconnect notify prompt 638 sent to the BT headset.

FIG. 6D illustrates the gain/release sub-process 614 according to one embodiment of the invention. In a first step, the wireless communication device determines the state of the push to talk session 650. In one embodiment, the state of the control switch on the wireless communication device is determined 652. Alternatively, the state of the call button on the headset can be determined if the wireless communication device is in the Bluetooth push to talk mode.

At decision 654, the state of the call button determines whether to attempt to gain the floor or release the floor. In one embodiment, the activation of the call button causes the Bluetooth headset to send the AT_CKPD_{—}200 message to the wireless communication device in an attempt to gain the floor 656. The wireless communication device transmits an audio signal to the Bluetooth headset to indicate to the user the status of the floor 658. In one embodiment, the audio signal is transmitted through the serial interface between the devices over the in-band channel not used for standard voice communications. The Bluetooth module in the wireless device transmits the VK Code to the push to talk application 660 to initiate the Bluetooth push to talk session. In one embodiment, once a user gains the floor, holding the floor can be limited by a programmable watchdog timeout. In one embodiment, immediately upon connection, the serial port profile (SPP) and the Synchronous Connection Oriented link (SCO) connections to the Bluetooth headset are opened and the headset mike path is muted.

In one embodiment, when the user gains the floor during the Bluetooth push to talk session, the headset speaker path is muted and the microphone path is engaged. When the user releases the floor, the headset speaker path is opened and the microphone path is muted.

In one embodiment, the activation of the call button causes the Bluetooth headset to send the AT_CKPD_{—}201 message to the wireless communication device to release the floor 662. In one embodiment, the wireless communication device restores the audio signal path between the devices 664 so that the Bluetooth headset is prepared to receive audio from the wireless communication device when another user gains the floor. The Bluetooth module in the wireless device transmits the VK Code to the push to talk application 668 to release the floor in the Bluetooth push to talk session.

In one embodiment, the Bluetooth push to talk process is mutually exclusive of the standard Bluetooth voice calling mode. For example, the relationship between the Bluetooth headset and the wireless communication device can only operate in the push to talk mode or a standard voice calling mode at one time.

One illustrative method of the Bluetooth push to talk process according to the invention is described as follows. The push to talk extension is enabled in the Bluetooth protocol stack in the wireless communication device. A Bluetooth headset having a call button is paired to the wireless communication device.

When the headset call button is initially activated, an in-band notification from the push to talk client on the wireless communication device is heard through the loudspeaker in the headset indicating that the user has gained the floor. The user can speak into the microphone to record a push to talk call burst or to speak live to session participants. Recording is ended when the user releases the floor.

The user is alerted (in-band) about an incoming push to talk session by the push to talk client on the wireless communication device. The user can accept or reject incoming session using the user interface of the wireless communication device. The user requests the floor and releases the floor using the call button on the headset. In one embodiment, the transmission of a push to talk call burst by the push to talk client can begin before the recording of the call burst has ended.

If the floor request is queued, and access to the floor is not immediately granted, the user can cancel the floor request from the call button on the Bluetooth headset. In one embodiment, the user cannot gain the floor during an ongoing phone call using the Bluetooth headset. In one embodiment, the user can initiate and/or terminate a push to talk session through a user interface on the wireless communication device.

The user can also send a push to talk invitation (i.e., a message requesting that the other party call) using the user interface of the wireless communication device. The user can also accept a push to talk invitation (i.e., to initiate a push to talk session with the sender of the invitation) using the user interface of the wireless communication device.

In alternate embodiments, multiple push to talk-sessions, parallel push to talk-sessions, and the like, can be managed by the push to talk client on the wireless communication device. For example, alerts, call status indicators, and calling line identifications can be managed by the push to talk client on the wireless communication device. Additionally, contact management can be managed by the push to talk client on the wireless communication device.

The foregoing description is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present invention as set forth in the claims that follow. In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A wireless communication device comprising:
a wireless transceiver capable of communicating with a Bluetooth-enabled wireless device having a call button for initiating a command;
a control switch that is coupled to the wireless transceiver for initiating a push to talk session in the wireless transceiver; and
a processor coupled to the control switch and the wireless transceiver, the processor initiating the push to talk session upon receiving the command from the Bluetooth-enabled wireless device.

2. The wireless communication device of claim 1 wherein initiating the push to talk session comprises attempting to gain the floor.

3. The wireless communication device of claim 1 wherein the command is transmitted to the wireless transceiver upon momentary activation of the call button.

4. The wireless communication device of claim 1 wherein the Bluetooth-enabled wireless device comprises a transceiver.

5. The wireless communication device of claim 1 wherein the Bluetooth-enabled wireless device comprises a loudspeaker and a microphone.

6. The wireless communication device of claim 1 wherein the call button of the Bluetooth-enabled wireless device is capable of initiating different commands in response to activating the call button for different durations.

7. The wireless communication device of claim 6 wherein activating the call button for a predetermined duration initiates text-to-speech functionality in the wireless communication device.

8. A method comprising:
pairing a Bluetooth-enabled wireless device having a call button to a wireless communication device having a wireless transceiver;
activating the call button on the Bluetooth-enabled wireless device to send a command to the wireless communication device; and
initiating a push to talk session in the wireless communication device in response to the command from the Bluetooth-enabled wireless device.

9. The method of claim 8 wherein the pairing comprises a fast-pairing.

10. The method of claim 8 wherein initiating the push-to-talk session comprises one of gaining the floor and releasing the floor.

11. The method of claim 8 wherein the activating comprises pushing the call button on the Bluetooth-enabled wireless device.

12. The method of claim 8 wherein the push to talk session in the wireless communication device is initiated by intercepting the command from the Bluetooth-enabled wireless device in the wireless communication device.

13. The method of claim 8 wherein activating the call button for different durations results in initiating different commands in the wireless communication device.

14. A wireless communication system comprising:
a Bluetooth-enabled wireless device having a call button for initiating a command; and
a wireless communication device having a wireless transceiver that is capable of communicating with the Bluetooth-enabled wireless device and a processor that initiates a push to talk session in the wireless communication device upon receiving the command from the Bluetooth-enabled wireless device.

15. The wireless communication system of claim 14 wherein the processor initiates the push to talk session by attempting to gain the floor.

16. The wireless communication system of claim 14 wherein the processor terminates the push to talk session by releasing the floor.

17. The wireless communication system of claim 14 further comprising a control switch that is coupled to the wireless transceiver for activating push to talk functionality in the wireless communication device.

18. The wireless communication system of claim 14 wherein the wireless communication device comprises one of a cellular telephone, mobile computer, desktop computer, personal digital assistant (PDA) and a walkie-talkie.

19. The wireless communication system of claim 14 wherein the call button initiates various commands in the wireless communication device as a function of at least one of the length and frequency of an activation of the call button.

20. The wireless communication system of claim 14 wherein the Bluetooth-enabled wireless device comprises a transceiver, a loudspeaker and a microphone.
